(19) United States
(12) Patent Application Publication
(10) Pub. No.: US 2007/0277087 A1
(43) Pub. Date: Nov. 29, 2007

(54) IMAGE FORMING APPARATUS, CONTROL METHOD FOR THE APPARATUS, PROGRAM FOR IMPLEMENTING THE METHOD, AND STORAGE MEDIUM STORING THE PROGRAM

(75) Inventor: Kotaro MATSUDA, Kawasaki-shi (JP)

Correspondence Address: ROSSI, KIMMS & McDOWELL LLP., P.O. BOX 826, ASHBURN, VA, 20146-0826, US

(73) Assignee: CANON KABUSHIKI KAISHA, Tokyo (JP)

(21) Appl. No.: 11/753,084

(22) Filed: May 24, 2007

(30) Foreign Application Priority Data
May 25, 2006 (JP) 2006-145451

(51) Int. Cl. G06F 17/00

(52) U.S. Cl. 715/500

(57) ABSTRACT

An image forming apparatus which can suitably control energy-saving control for functional modules operated with respect to respective applications. An installation controller designates energy-saving control conditions for at least one functional module with respect to each application of the image forming apparatus. An energy-saving controller controls the energy-saving state of the functional module according to the designated energy-saving control conditions.

### BACKGROUND OF THE INVENTION

1. Field of the Invention

The present invention relates to an image forming apparatus, a control method for the apparatus, a program for implementing the method, and a storage medium storing the program.

2. Description of the Related Art

An MFP (Multi Function Peripheral) having a plurality of functions such as a copy function, a printer function, a scanner function, and a facsimile function has plurality of devices and a plurality of applications incorporated therein so as to realize the above-mentioned functions. Each of the applications causes at least one of the devices to realize an associated function.

An application operation environment, notably a Java® environment, is provided for the MFP. Accordingly, if an application running in an environment such as the Java® environment is created and installed in the MFP so as to enhance the functions and usability of the MFP, a desired function can be realized by the installed application. Namely, the advent of an MFP which can realize a desired function using a newly created application installed therein is desired.

Also, as an environmental protection measure, a control technique for suppressing the waste of power i.e. energy saving has been proposed (see e.g. Japanese Laid-Open Patent Publication (Kokai) No. 2001-285543). With this control technique, information relating to histories of execution of applications installed in advance and operation modes, and information relating to devices used for the respective applications are acquired. By referring to the acquired information as well as information indicative of the relationship between the operation modes of the respective applications and the need to provide energy-saving control for the devices, energy-saving control is provided for the devices which require energy-saving control. Specifically, the timing in which the shift of a device which requires energy-saving control to an energy-saving state is started is determined.

In the case where a new application to be installed in image forming apparatuses including the MFP described above is created, it can be envisaged that a control means for saving energy is incorporated in this application. According to the conventional technique, however, power-saving control is provided based on the histories of execution of applications incorporated in advance, it is difficult to suitably provide energy-saving control for a device which is to be used by a newly installed application.

### SUMMARY OF THE INVENTION

The present invention provides an image forming apparatus which can suitably provide energy-saving control for functional modules operated with respect to respective applications, a control method for the apparatus, a program for implementing the method, and a storage medium storing the program.

In a first aspect of the present invention, there is provided an image forming apparatus including at least one functional module, comprising a designating unit adapted to designate energy-saving control conditions for at least one functional module with respect to each application of the image forming apparatus, and an energy-saving control unit adapted to control an energy-saving state of the functional module according to the energy-saving control conditions designated with respect to each application by the designating unit.

The application can be associated with a manifest in which energy-saving control conditions for at least one functional module for realizing one function are described.

The energy-saving control conditions can include an energy-saving canceling condition for canceling an energy-saving state of the functional module operated by the application, and an energy-saving starting condition for causing the functional module operated by the application to shift to the energy-saving state.

The energy-saving starting condition can include levels of energy-saving state of the functional module operated by the application.

The energy-saving starting condition can include a period of time to elapse until the functional module operated by the application is caused to shift to the energy-saving state.

The energy-saving control conditions can include an energy-saving restraint canceling condition for canceling an energy-saving restrained state in which the functional module operated by the application is restrained from shifting to the energy-saving state, and an energy-saving restraint starting condition for causing the functional module operated by the application to shift to the energy-saving restrained state, and the energy-saving control unit can be adapted to carry out an energy-saving control process including cancellation of the energy-saving state of the functional module operated by the application and shift of the functional module operated by the application to shift to the energy-saving state, and cancellation of the energy-saving restrained state and shift to the energy-saving state.

In a second aspect of the present invention, there is provided a method of controlling an image forming apparatus including at least one functional module, comprising a designating step of designating energy-saving control conditions for at least one functional module with respect to each application of the image forming apparatus, and an energy-saving control step of controlling an energy-saving state of the functional module according to the energy-saving control conditions designated with respect to each application in the designating step.

The application can be associated with a manifest in which energy-saving control conditions for at least one functional module for realizing one function are described.

The energy-saving control conditions can include an energy-saving canceling condition for canceling an energy-saving state of the functional module operated by the application, and an energy-saving starting condition for causing the functional module operated by the application to shift to the energy-saving state.

The energy-saving starting condition can include levels of energy-saving state of the functional module operated by the application.

The energy-saving starting condition can include a period of time to elapse until the functional module operated by the application is caused to shift to the energy-saving state.

The energy-saving control conditions can include an energy-saving restraint canceling condition for canceling an energy-saving restrained state in which the functional module operated by the application is restrained from shifting to the energy-saving state, and an energy-saving restraint starting condition for causing the functional module operated by the application to shift to the energy-saving restrained state, and an energy-saving control process can be carried out in the energy-saving control step, the energy-saving control process including cancellation of the energy-saving state of the functional module operated by the application and shift of the functional module operated by the application to shift to the energy-saving state, and cancellation of the energy-saving restrained state and shift to the energy-saving state.

In a third aspect of the present invention, there is provided a program for causing a computer to execute a method of controlling an image forming apparatus including at least one functional module, comprising a designating module for designating energy-saving control conditions for at least one functional module with respect to each application of the image forming apparatus, and an energy-saving control module for controlling an energy-saving state of the functional module according to the energy-saving control conditions designated with respect to each application by the designating module.

In a fourth aspect of the present invention, there is provided a computer-readable storage medium storing the above mentioned program.

According to the present invention, it is possible to suitably provide energy-saving control for functional modules operated with respect to respective applications.

Further features will become apparent from the following description of exemplary embodiments with reference to the attached drawings.

### BRIEF DESCRIPTION OF THE DRAWINGS

FIG. 1 is a diagram schematically showing an example of the construction of a system including an image forming apparatus according to a first embodiment of the present invention;

FIG. 2 is a block diagram showing the construction of an MFP appearing in FIG. 1;

FIG. 3 is a block diagram showing the internal construction of a controller of the MFP appearing in FIG. 2;

FIG. 4 is a block diagram showing a software configuration capable of executing application programs in the MFP appearing in FIG. 2;

FIG. 5 is a view showing an example of a user interface screen provided by an application A appearing in FIG. 4;

FIG. 6 is a block diagram showing a construction that enables a framework to provide energy-saving control appearing in FIG. 4;

FIG. 7 is a diagram showing the relationship between the lifecycle of an application and energy-saving control provided for this application according to the first embodiment;

FIG. 8 is a view showing an example of a manifest of the application appearing in FIG. 7;

FIG. 9 is a view showing another example of the manifest of the application appearing in FIG. 7;

FIG. 10 is a view showing still another example of the manifest of the application appearing in FIG. 7;

FIGS. 11A and 11B are diagrams showing a control sequence carried out based on the manifest of the application in FIG. 10;

FIG. 12 is a diagram showing an example of a table showing energy-saving states and energy-saving suppressing states of functional modules managed by an energy-saving controller;

FIG. 13 is a flow chart showing the procedure of an energy-saving control process carried out by the energy-saving controller; and

FIG. 14 is a block diagram showing a software configuration capable of executing application programs in an image forming apparatus according to a second embodiment of the present invention.

### DETAILED DESCRIPTION OF THE PREFERRED EMBODIMENTS

The present invention will now be described in detail with reference to the drawings showing preferred embodiments thereof.

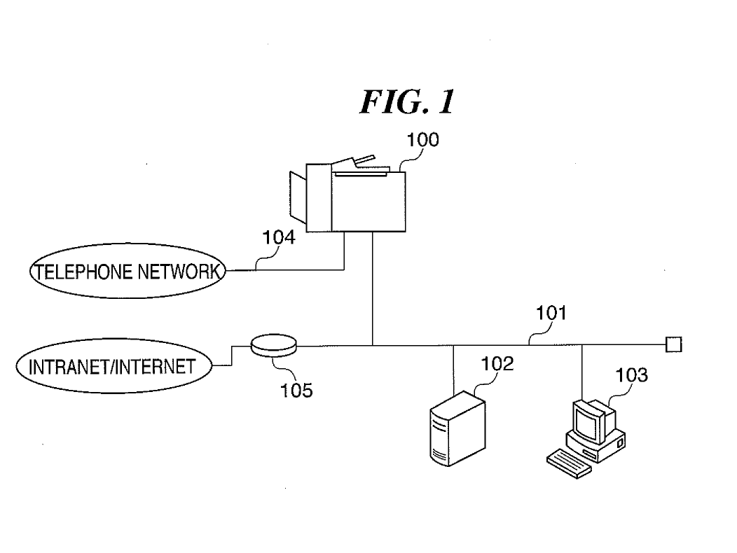

FIG. 1 is a diagram schematically showing an example of the construction of a system including an image forming apparatus according to a first embodiment of the present invention. In the following description of the first embodiment, it is assumed that the image forming apparatus is a multi function peripheral having a plurality of functions.

The multi function peripheral (hereinafter referred to as “the MFP”) 100 having a plurality of functions such as a copy function, a printer function, a scanner function, and a facsimile function is connected to a network 101 such as a LAN and also connected to a telephone line 104 as shown in FIG. 1. Also, the network 101 houses a server computer (hereinafter referred to as “the server”) 102, a personal computer (hereinafter referred to as “the PC”) 103, and a gateway device 105.

The server 102 is used as an electronic mail server, a document management server, and so on. The PC 103 is equipped with a printer driver for carrying out printing. The gateway device 105 is used for connection to an intranet, the Internet, and so on.

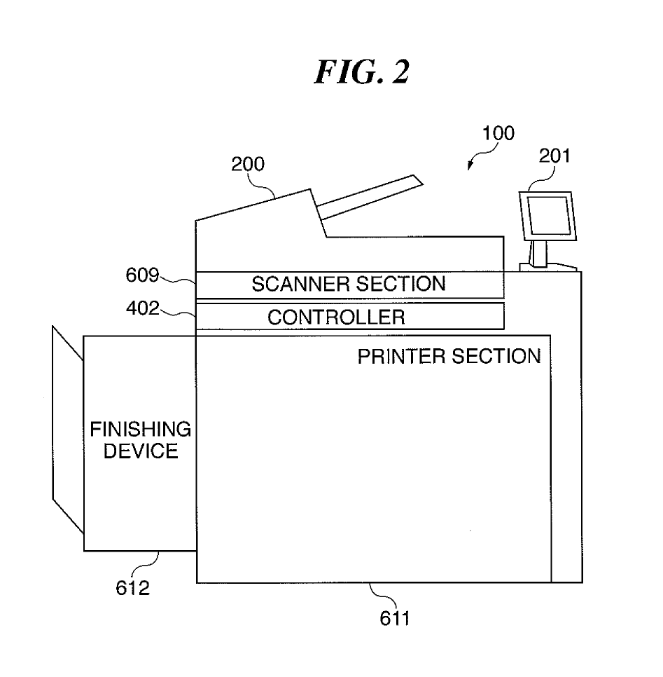

Next, a description will be given of the construction of the MFP 100 with reference to FIG. 2. FIG. 2 is a block diagram showing the construction of the MFP 100 appearing in FIG. 1.

As shown in FIG. 2, the MFP 100 is comprised of a plurality of functional modules such as an automatic original feeder 200, a scanner section 609, an operation panel 201, a printer section 611, and a finishing device 612. These functional modules are controlled by a controller 402.

The automatic original feeder 200 is for automatically conveying originals to the scanner section 609. The scanner section 609 reads an original conveyed from the automatic original feeder 200 and outputs image data which represents an image on the read original. The printer section 611 is a printer that prints out image data output from the scanner section 609 or from the PC 103 or the server 102 on the network 103 by an electrophotographic process. Although not illustrated, the printer section 611 is comprised of an image forming section that forms a toner image, a transfer section that transfers the toner image onto a sheet, a fixing section that fixes the toner image, which has been transferred onto the sheet, on the sheet, and so on.

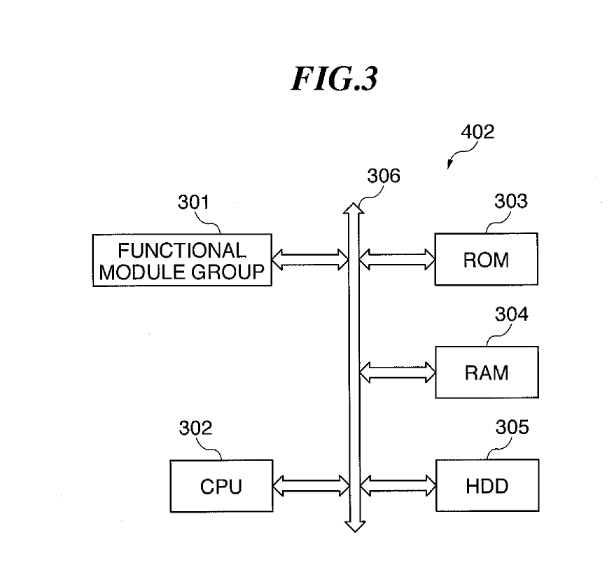

Next, a description will be given of the construction of the controller 402 with reference to FIG. 3. FIG. 3 is a block diagram showing the internal construction of the controller 402 of the MFP 100 appearing in FIG. 2.

As shown in FIG. 3, the controller 402 is comprised of a CPU 302 that constructs an OS (operating system) in accordance with a program stored in a ROM 303. The CPU 302 controls the overall operation of the MFP 100 and individually controls functional modules included in a functional module group 301 in accordance with control programs running on the OS. The control programs are stored in the ROM 303 or an HDD (hard disk drive) 305. When the CPU 302 provides control, a RAM 304 is used as a working area for the CPU 302. These blocks are connected to one another via an input/output interface 306.

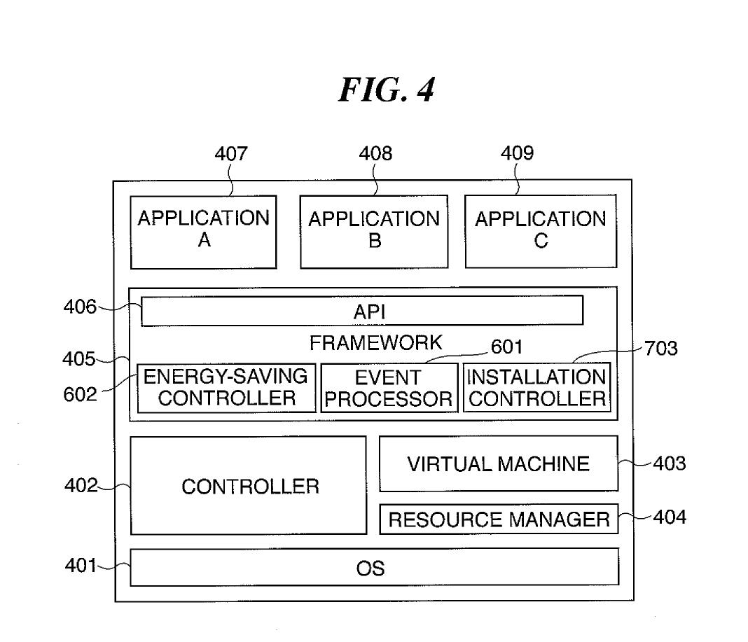

Referring next to FIG. 4, a description will be given of a software configuration capable of executing application programs in the MFP 100. FIG. 4 is a block diagram showing the software configuration capable of executing application programs in the MFP 100.

As shown in FIG. 4, on the MFP 100, the CPU 302 constructs a real-time OS 401 for controlling various functions of the MFP 100 in real time. The OS 401 provides an operation environment for various applications and provides interface commands to higher-level applications. The controller 402, a virtual machine 403, and a resource managing section 404 operate in the operation environment provided by the OS 401.

The controller 402 is comprised of a plurality of modules for controlling the respective functional modules included in the functional module group 301. The virtual machine 403 provides the optimum operation environment for operating a specific application and is realized by, for example, a Java®. The resource managing section 404 manages resources so that, when all the applications on the virtual machine 403, a framework 405, described later, or the OS 401 use resources, they do not use resources exceeding a predetermined amount.

The framework 405 is a framework for applications executed in the operation environment provided by the virtual machine 403. The framework 405 includes an application programming interface (hereinafter referred to as “the API”) 406. It is assumed here that the applications executed by the framework 405 consist of an application 407 (an application A), an application 408 (an application B), and an application 409 (an application C).

Required services to be shared, functional modules to be frequently used, library groups required to access the controller 402 and control various functions of the MFP 100, and so on are prepared in advance in the framework 405. Thus, the above-mentioned applications 407 to 409 and others can be efficiently developed and operated using the API 406. In the present embodiment, an energy-saving controller 602, an event processor 601, and an installation controller 703 are incorporated in the framework 405. Detailed description thereof will be given later.

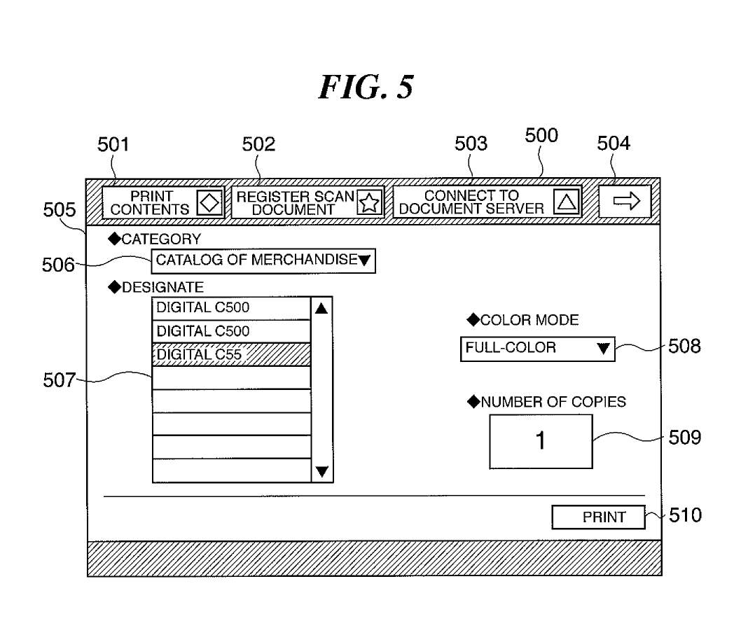

Referring next to FIG. 5, a description will be given of functions provided by the applications 407 to 409 and how they are selected. FIG. 5 is a view showing an example of a user interface screen provided by the applications 407 to 409 in FIG. 4.

In selecting functions provided by the applications 407 to 409, a user interface screen 500 as shown in FIG. 5 for selecting and designating functions provided by the applications 407 to 409 is displayed on the operation panel 201. It is assumed here that the functions provided by the applications 407 to 409 are a “contents print” function, a “scan document registration” function, and a “document server connection” function, respectively. In this case, displayed on the user interface screen 500 are buttons 501, 502, and 503 for selecting and designating the “contents print” function, the “scan document registration” function, and the “document server connection” function provided by the applications 407, 408, and 409, respectively. Also, in the case where all the functions provided by the applications 407 to 409 cannot be displayed on one screen, a scroll button 504 for scrolling through screens is displayed.

Also, the user interface screen 500 includes a panel control area 505 for inputting set values which are to be used by an application corresponding to a selected function. In the panel control area 505, input boxes 506, 507, 508, and 509 for inputting various set values to be used by an associated application are displayed. Also, on the user interface screen 500, a print button 510 for instructing the start of printing by a selected application in accordance with input set values is displayed. The panel control area 505 displayed here is associated with the “contents print” function provided by the application 407.

The illustrated applications 407 to 409 are of the type which uses a user interface, notably an applet, but applications executable by the framework 405 should not be limited to this type. For example, various applications such as an application such as a servlet which can provide a Web interface, and an application such as a service which continues processing in background can be executed.

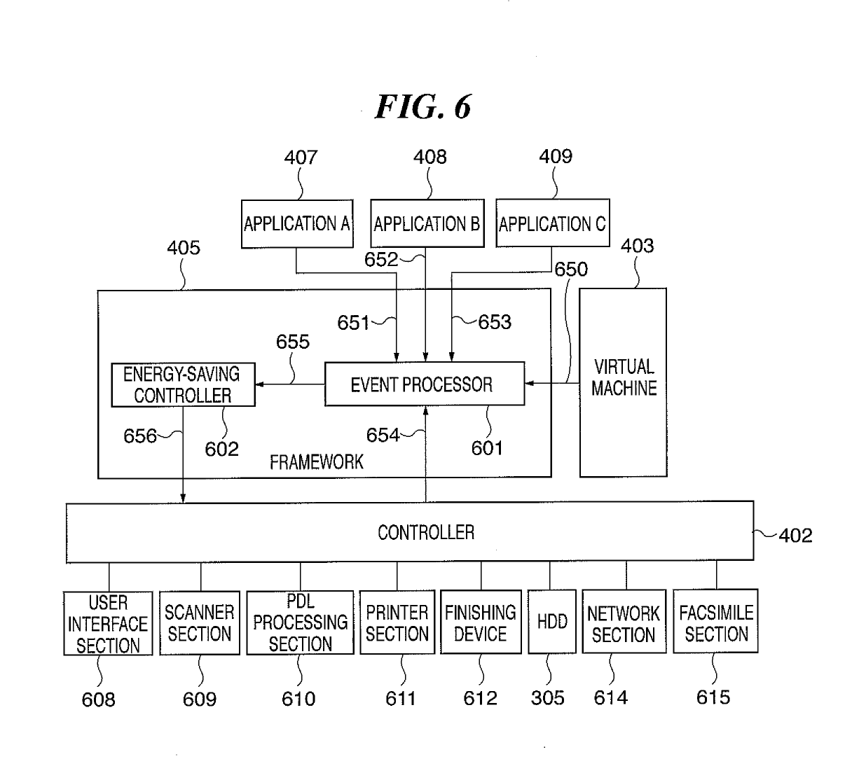

Referring next to FIG. 6, a description will be given of a construction that enables the framework 405 to provide energy-saving control. FIG. 6 is a block diagram showing the construction that enables the framework 405 to provide energy-saving control appearing in FIG. 4.

As shown in FIG. 6, the event processor 601 incorporated in the framework 405 receives events 654 related to the respective functional modules from the controller 402 and receives unique events 650 from the virtual machine 403. Also, the event processor 601 receives events from the OS 401, unique events 651 to 653 from the respective applications 407 to 409, and so on. The event processor 601 performs processing suitable for received events.

The energy-saving controller 602 incorporated in the framework 405 monitors an event notification 655 from the event processor 601 and issues a processing instruction 656 for controlling the energy-saving states of the functional modules via the controller 402.

Here, among the functional modules controlled by the controller 402, functional modules of which energy-saving state is to be controlled include a user interface section 608, the scanner section 609, a PDL processing section 610, and the printer section 611. In addition, functional modules of which energy-saving state is to be controlled also include a finishing device 612, an HDD 305, a network section 614, a facsimile section 615, and so on. Each of these functional modules is defined as the minimum unit of modules of which energy-saving state can be individually controlled by the energy-saving state controller 602. The printer section 611 is provided with a plurality of modules such as a sheet feed section, an image forming section, a fixing section, and a sheet discharge section. If the energy-saving states of these modules such as the sheet feed section, the fixing section, and the sheet discharge section can be controlled independently of one another, each of them is defined as the minimum unit of modules of which energy-saving state can be controlled. Conversely, if the energy-saving states of these modules such as the sheet feed section, the fixing section, and the sheet discharge section cannot be controlled independently of one another, the printer section 611 is defined as the minimum unit of modules of which energy-saving state can be controlled.

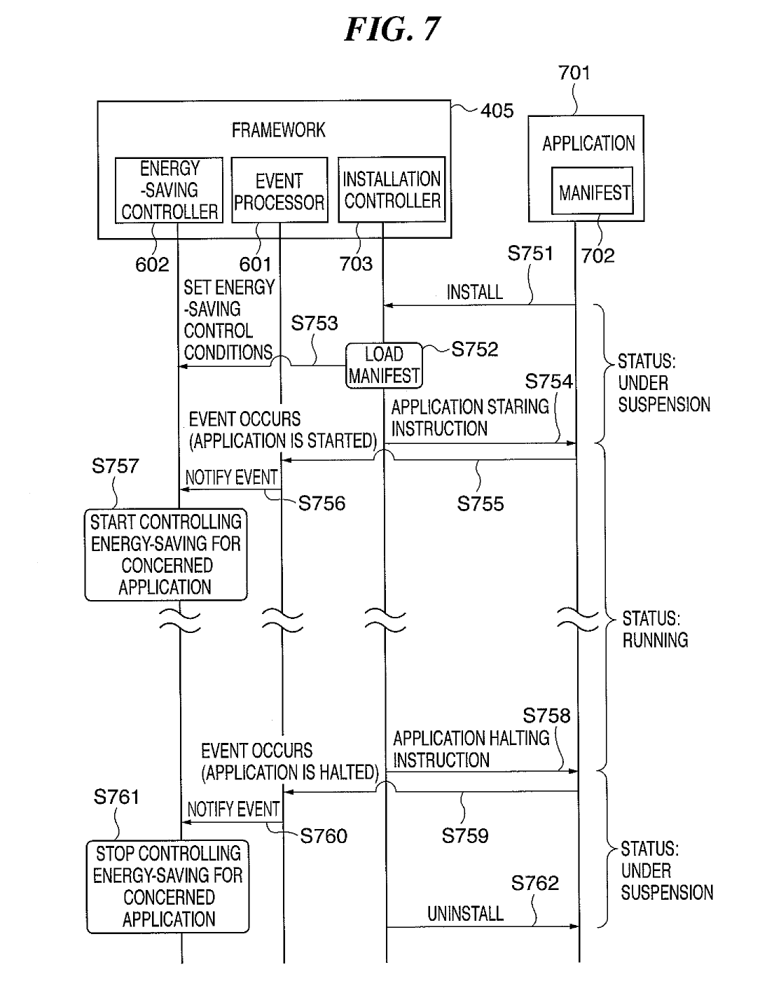

Referring next to FIG. 7, a description will be given of the relationship between the lifecycle of an application and energy-saving control provided for the application. FIG. 7 is a diagram showing the relationship between the lifecycle of an application and energy-saving control provided for the application according to the first embodiment of the present invention.

In the example illustrated in FIG. 7, it is assumed that one application 701 is installed and uninstalled. The application 701 includes a manifest 702 in which operation setting information on the application 701 and others are described. An example of the manifest 702 will be described later in detail. An instillation controller 703 incorporated in the framework 405 manages the lifecycle of an application such as instillation, activation, stop, and uninstillation.

First, the application 701 is installed on the framework 405 through the installation controller 703 (step S751). After the installation, the installation controller 703 expands necessary files, loads libraries, and loads the manifest 702 (step S752). The installation controller 703 notifies the energy-saving controller 602 of energy-saving control conditions in the loaded manifest (step S753). The energy-saving controller 602 notified of the energy-saving control conditions sets the energy-saving control conditions.

The installation controller 703 sends an application starting instruction to the application 701 to start the application 701 (step S754). The application 701 performs a necessary initializing process and others, and when normally started, the application 701 sends an event which notifies that the application 701 has been normally started to the event processor 601 (step S755). The event processor 601 notifies the energy-saving controller 602 of the event (step S756), and the energy-saving controller 602 starts energy-saving control for a functional module which is to be operated by the application 701 (step S757).

In halting the application 701, the installation controller 703 sends an application halting instruction to the application 701 (step S758). The application 701 performs a necessary process in preparation for halting and others and sends an event which notifies the halt of the application 701 to the event processor 601 and then halts (step S759). The event processor 601 notifies the energy-saving controller 602 of the event (step S760), and the energy-saving controller 602 stops energy-saving control for the functional module operated by the application 701 (step S761). The installation controller 703 then uninstalls the application 701 (step S762).

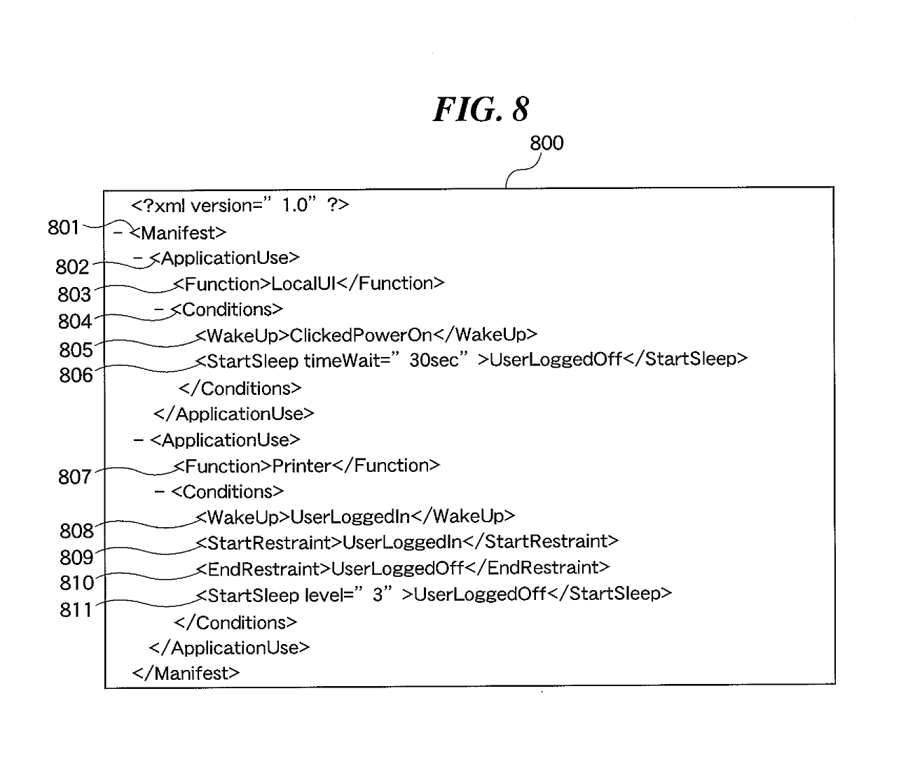

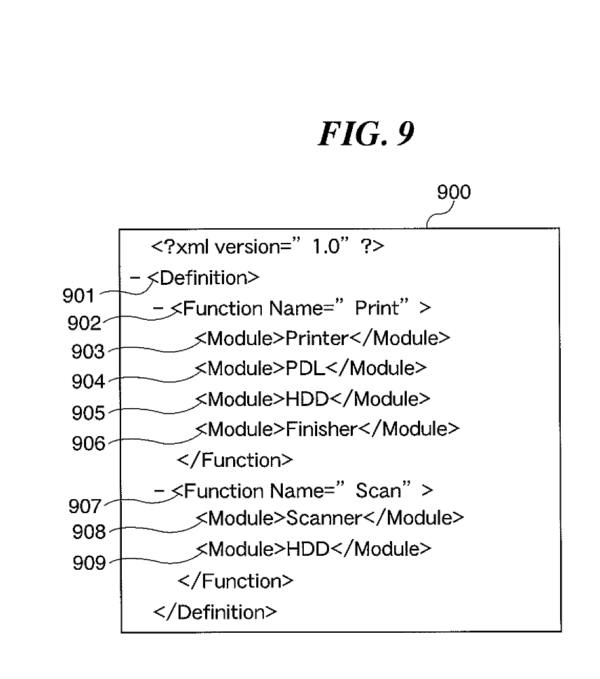

Referring net to FIGS. 8 and 9, a description will be given of an example of the manifest 702 of the application 701. FIG. 8 is a view showing an example of the manifest 702 of the application 701 appearing in FIG. 7. FIG. 9 is a view showing another example of the manifest 702 of the application 701 appearing in FIG. 7.

Examples of the manifest 702 of the application 701 include a manifest 800 described in XML (Extensible Markup Language) as shown in FIG. 8. In the illustrated manifest 800, a root node 801 and an “ApplicationUse” node 802 are described. The “ApplicationUse” node 802 includes a “Function” element 803 indicative of a module of which energy-saving state is to be controlled, and a “Conditions” node 804 for describing energy-saving conditions for the object to be controlled. For the “Conditions” node 804, a “Wakeup” element 805 indicative of an energy-saving canceling condition, and a “StartSleep” element 806 indicative of an energy-saving starting condition are described. In this illustrated example, it is described that regarding a function “LocalUI”, energy-saving is to be canceled on the condition that an event “ClickedPowerOn” occurs, and energy-saving is started on the condition that an event “UserLoggedOff” occurs. Also, a “timeWait” property of the “StartSleep” element 806 indicates that energy-saving should be started upon the lapse of 30 seconds after the occurrence of the event. For example, if the function “LocalUI” is frequently used, the “timeWait” property maintains the non energy-saving state of the function “LocalUI” for a long period of time, whereby the degradation of usability can be prevented.

Similarly, the illustrated manifest 800 includes a “Function” element 807 and an “Conditions” node thereof. Regarding this “Conditions” node, a “Wakeup” element 808 indicative of an energy-saving canceling condition, a “StartRestraint” element 809 indicative of an energy-saving restraint starting condition, an “EndRestraint” element 810 indicative of an energy-saving restraint ending condition, and a “StartSleep” element 811 indicative of an energy-saving starting condition are described. In this illustrated example, it is described that regarding a function module “Printer”, energy-saving is to be canceled on the condition that an event “UserLoggedIn” occurs, the restraint of energy-saving is to be started on the condition that an event “UserLoggedIn” occurs, the restraint of energy-saving is to be ended on the condition that an event “UserLoggedOff” occurs, and energy-saving is to be started on the condition that an event “UserLoggedOff” occurs. Also, a “level” property of the “StartSleep” element 811 can designate, for example, a level of energy-saving state in the case where there are various levels (graduated level) of energy-saving state. For example, with the “level” property, it is possible to determine the temperature to which the fixing section of the printer section 611 is to be lowered when the fixing section is in an energy-saving state. Thus, the reset time can be determined according to the user's usage environment within the range where usability is not degraded.

Here, in the above described manifest 800, identifiers corresponding to the respective functional modules 608 to 615 appearing in FIG. 6 can be directly written in the “Function” elements indicative of modules of which energy-saving state is to be controlled.

Also, a manifest 900 as shown in FIG. 9 can be used in place of the manifest 800. The manifest 900 is used in the case where functions declared in the manifest 800 are defined in advance. In the manifest 900, a root node 901, and a “Function” element 902 for designating a function are written. The name of a function is written as a property “Name” of the “Function” element 902. The “Function” element 902 includes a plurality of “Module” elements 903 to 906, and the names of modules of the MFP 100 to be used are written as the respective “Module” elements 903 to 906. The “Function” element 902 designates a “Print” function. Also, the plurality of “Module” elements 903 to 906 declare that modules to be used by the “Print” function are “Printer” (the printer section 611), “PDL” (the PDL processor 610), “HDD” (the HDD 305), and a “Finisher” (the finishing device 612). By writing ‘Print’ as the “Function” element 902, identifiers of functional modules of the MFP can be written in an indirect manner. Thus, the manifest 900 is useful in the case where several functional modules are regarded as one functional module which is an object to be controlled.

Also, in the manifest 900, a “Function” element 907 designates a function “Scan.” Also, “Module” functions 908 and 909 declare that modules to be used by the function “Scan” are “Scan” (the scanner section 609) and an “HDD” (the HDD 305).

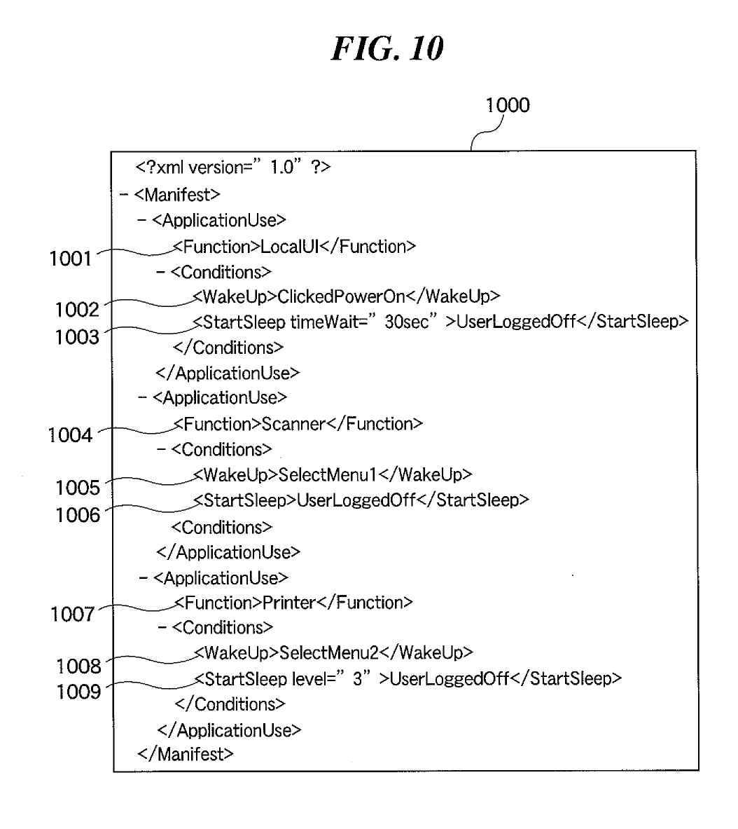

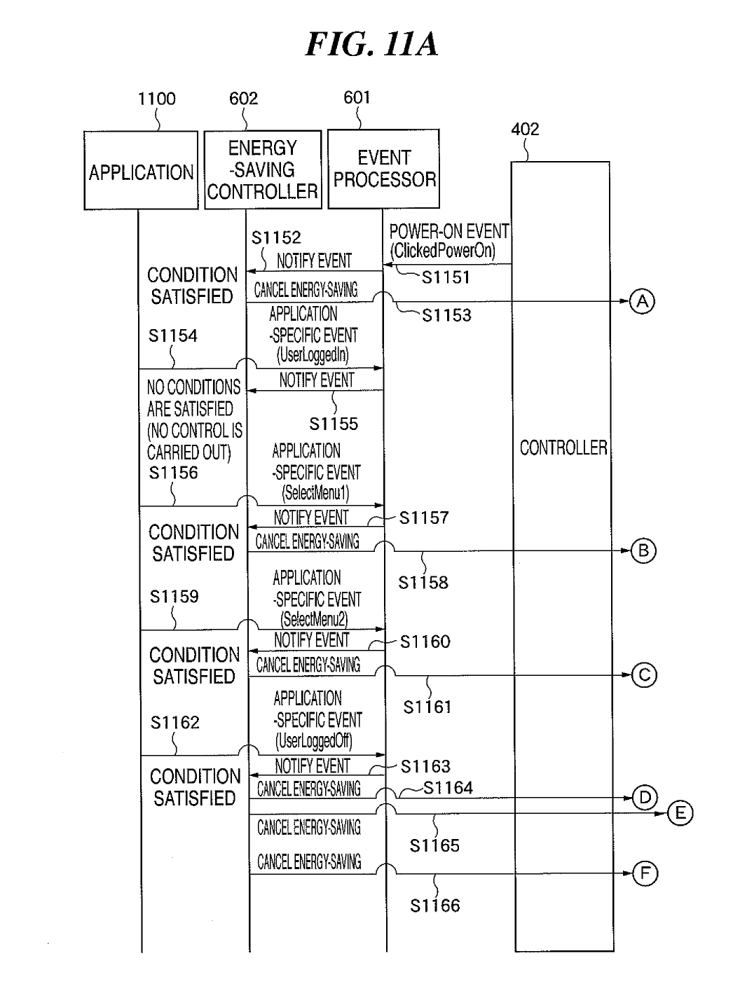

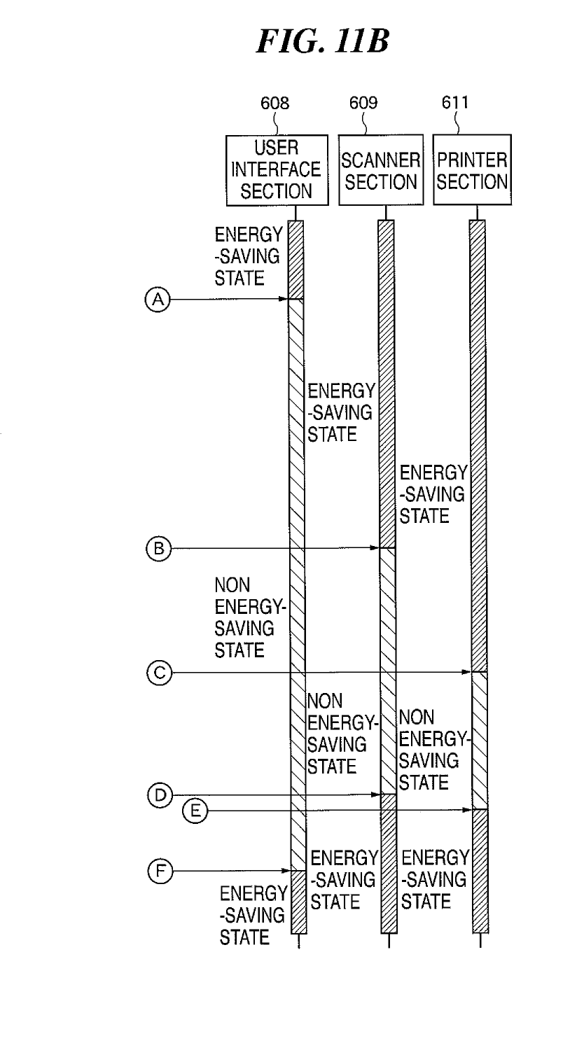

Referring next to FIGS. 10 and 11, a description will be given of energy-saving control provided with execution of an application. FIG. 10 is a view showing another example of the manifest of an application used in the first embodiment of the present invention. FIGS. 11A and 11B are diagrams showing a control sequence carried out based on the manifest of the application in FIG. 10.

In the following description, it is assumed that energy saving is controlled when an application 1100 including a manifest 1000 shown in FIG. 10 is executed. As shown in FIG. 10, in the manifest 1000, energy-saving canceling conditions 1002, 1005, and 1008 and energy-saving starting conditions 1003, 1006, and 1009 for a “LocalUI” function 1001, a “Scanner” function 1004, and a “Printer” function 1008 are described. Regarding the “LocalUI” function 1001, it is described the energy-saving canceling condition 1002 is that a “ClickedPoweron” event occurs, and the energy-saving starting condition 1003 is that a “UserLoggedOff” event occurs. Also, it is described that energy-saving is started upon the lapse of a waiting time of 30 seconds after the occurrence of the event. Regarding the “Printer” function 1007, it is described the energy-saving canceling condition 1008 is that a “SelectMenu2” event occurs, and the energy-saving starting condition 1009 is that a “UserLoggedOff” event occurs. The number “3” is designated as the level of energy-saving started on the energy-saving starting condition.

First, as shown in FIG. 11A, upon detecting a user's power-on operation, the controller 402 notifies the event processor 601 of a power-on event “ClickedPowerOn” (step S1151). The event processor 601 notifies the energy-saving controller 602 of the event (step S1152). The energy-saving controller 602 determines that the event matches the energy-saving canceling condition 1002 and cancels the energy-saving state of the user interface section 608 via the controller 402 (step S1153) (FIG. 11B).

Then, the application 1100 notifies the event processor 601 of an application-specific event “UserLoggedIn” (step S1154), and the event processor 601 notifies the energy-saving controller 602 of the event (step S1155). However, conditions relating to the event are not described in the manifest 1000, and hence no control process is carried out.

Then, the application 1100 notifies the event processor 601 of an application-specific event “SelectMenu1” (step S1156), and the event processor 601 notifies the energy-saving controller 602 of the event (step S1157). Here, the energy-saving controller 602 determines that the event matches the energy-saving canceling condition 1005 and cancels the energy-saving state of the scanner section 609 via the controller 402 (step S1158).

Then, the application 1100 notifies the event processor 601 of an application-specific event “SelectMenu2” (step S1159), and the event processor 601 notifies the energy-saving controller 602 of the event (step S1160). Here, the energy-saving controller 602 determines that the event matches the energy-saving canceling condition 1008 and cancels the energy-saving state of the scanner section 609 via the controller 402 (step S1161).

Then, the application 1100 notifies the event processor 601 of an application-specific event “UserLoggedOff” (step S1162), and the event processor 601 notifies the energy-saving controller 602 of the event (step S1163) Here, the energy-saving controller 602 determines that the event matches the energy-saving starting condition 1003 and starts causing the scanner section 609 to shift to an energy-saving state via the controller 402 (step S1164). Also, the energy-saving controller 602 determines that the event matches the energy-saving starting condition 1006 and starts causing the printer section 611 to shift to an energy-saving state via the controller 402 (step S1165). On this occasion, due to the “timewait” property of the energy-saving starting condition 1003, the energy-saving controller 602 waits for 30 seconds and then starts causing the user interface section 608 to shift to an energy-saving state (step S1166).

In the above description, it is assumed that the energy-saving state of a functional module as an object to be controlled is canceled in response to a user's power-on operation, but some functional modules as objects to be controlled are always in a non energy-saving state. In this case, even if a received event matches an energy-saving canceling condition, it is actually unnecessary to provide control for canceling the energy-saving state of an associated functional module. For this reason, the energy-saving controller 602 holds a table showing energy-saving states and energy-saving restrained states of functional modules. If a received event matches an energy-saving control condition, the energy-saving controller 602 refers to the table and provides control to cancel the energy-saving state of a functional module as an object to be controlled or causing the functional module to shift to an energy-saving state according to the current state of the functional module.

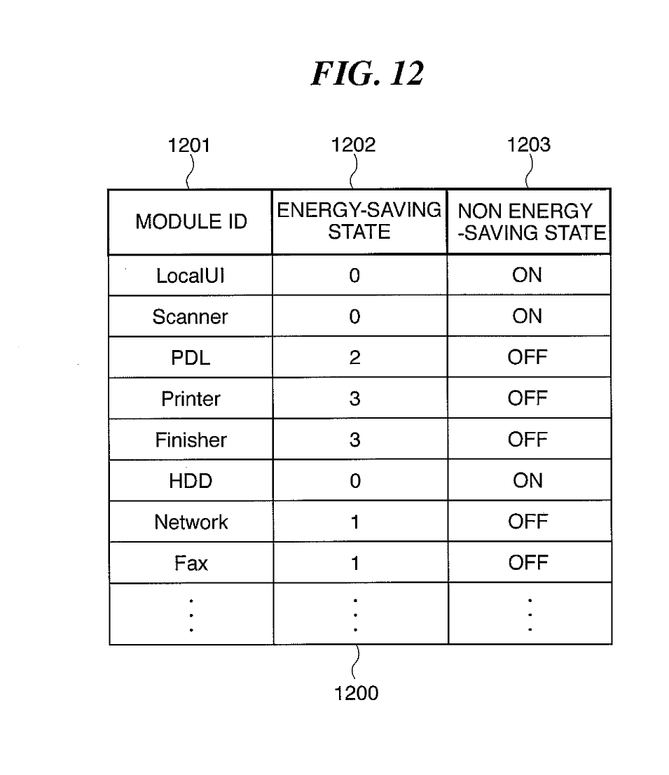

Referring to FIG. 12, a description will be given of the table which shows energy-saving states and energy-saving restrained states of functional modules managed by the energy-saving controller 602. FIG. 12 is a view showing the table which shows energy-saving states and energy-saving restrained states of functional modules managed by the energy-saving controller 602.

The energy-saving controller 602 manages energy-saving states and energy-saving restrained states of functional modules using a table 1200 shown in FIG. 12. In the table 1200, module IDs 1201, which are identifiers of respective functional modules, and energy-saving states 1202 and energy-saving restrained states 1203 associated with the respective module IDs 1201 are written.

Here, regarding the energy-saving states 1201, the value “0” indicates an energy-saving canceled state, and other values indicate energy-saving states. The values “1”, “2”, “3”, etc. of energy-saving state indicate energy-saving levels. Regarding the energy-saving restrained states 1203, “ON” and “OFF” indicate whether the restraint of energy-saving is enabled or disabled. “ON” indicates that even when an energy-saving starting instruction is issued, an associated functional module is not caused to shift to an energy-saving state. On the other hand, “OFF” indicates that the restraint of energy-saving is disabled, and an associated functional module can be caused to shift to an energy-saving state in response to the issuance of an energy-saving starting instruction.

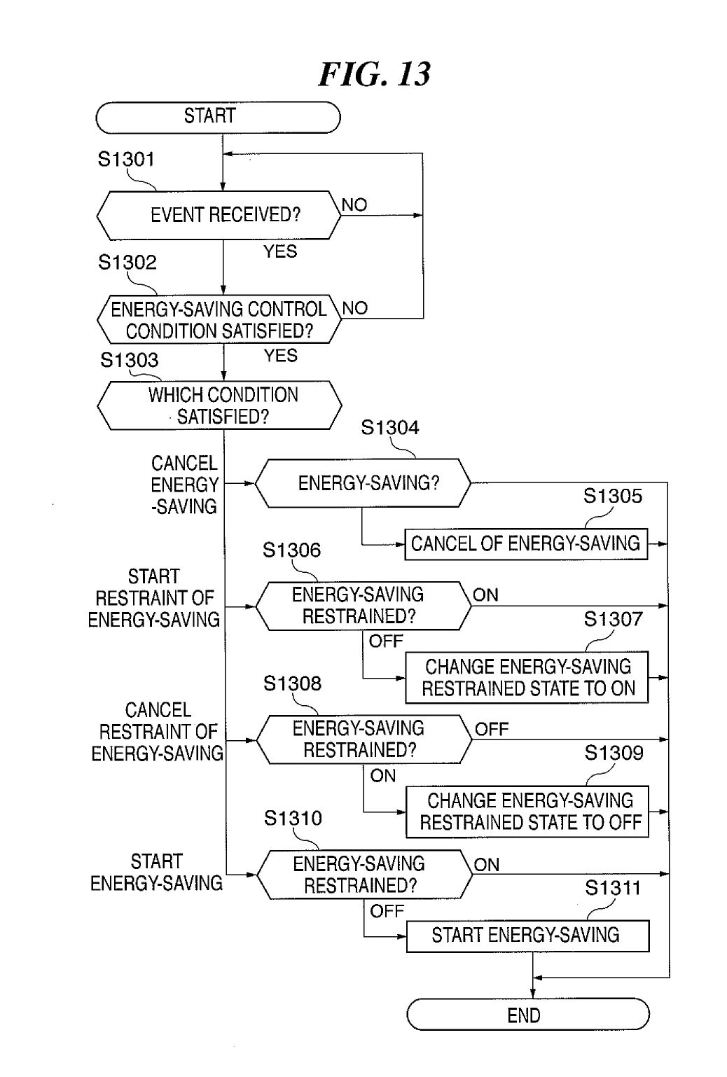

Referring next to FIG. 13, a description will be given of an energy-saving control process carried out by the energy-saving controller 602. FIG. 13 is a flow chart showing the procedure of the energy-saving control process carried out by the energy-saving controller 602.

As shown in FIG. 13, the energy-saving controller 602 waits for the receipt of an event from the event processor 601 (step S1301) Upon receiving an event, the energy-saving controller 602 determines whether or not the received event matches energy-saving control conditions described in the manifest (step S1302). If the received event does not match the energy-saving control conditions, the energy-saving controller 602 returns to the step S1301. On the other hand, if the received event matches the energy-saving control conditions, the energy-saving controller 602 determines an energy-saving control condition that matches the received event (step S1303) Specifically, the energy-saving controller 602 determines which of the following conditions matches the received event: an energy-saving canceling condition, an energy-saving restraint starting condition, an energy-saving restraint canceling condition, and an energy-saving starting condition.

If it is determined in the step S1303 that the energy-saving control condition is the energy-saving canceling condition, the energy-saving controller 602 refers to the energy-saving states 1202 of the table 1200 and determine the energy-saving state of a functional module of which energy-saving state is to be controlled (step S1304). If the value indicative of the energy-saving state of the functional module of which energy-saving state is to be controlled is a value other than “0”, the energy-saving controller 602 cancels the energy-saving state of the functional module (step S1305). Then, the energy-saving controller 602 terminates the present process. On the other hand, if the value indicative of the energy-saving state of the functional module of which energy-saving state is to be controlled is “0”, the energy-saving controller 602 determines that the functional module lies in a non energy-saving state and terminates the present process without canceling the energy-saving state of the functional module.

If it is determined in the step S1303 that the energy-saving control condition is the energy-saving restraint starting condition, the energy-saving controller 602 refers to the energy-saving restrained states 1203 of the table 1200 and determines the energy-saving restrained state of the functional module of which energy-saving state is to be controlled (step S1306). If the energy-saving restrained state 1203 of the functional module of which energy-saving state is to be controlled is “OFF”, the energy-saving controller 602 changes the energy-saving restrained state 1203 of the functional module to “ON” (step S1307). As a consequence, even if an energy-saving starting instruction is given for the functional module, the functional module is not caused to shift to an energy-saving state. Then, the energy-saving controller 602 terminates the present process. On the other hand, if the energy-saving restrained state 1203 of the functional module of which energy-saving state is to be controlled is “ON”, the energy-saving controller 602 terminates the present process without causing the functional module to shift to an energy-saving state even if an energy-saving starting instruction is given for the functional module.

If it is determined in the step S1303 that the energy-saving control condition is the energy-saving restraint canceling condition, the energy-saving controller 602 refers to the energy-saving restrained states 1203 of the table 1200 and determines the energy-saving restrained state of the functional module of which energy-saving state is to be controlled (step S1308). If the energy-saving restrained state 1203 of the functional module of which energy-saving state is to be controlled is “ON”, the energy-saving controller 602 changes the energy-saving restrained state 1203 of the functional module to “OFF” (step S1309) As a consequence, the restraint of energy saving for the functional module is canceled, and the shift of the functional module to an energy-saving state in response to the issuance of an energy-saving starting instruction is enabled. Then, the energy-saving controller 602 terminates the present process. On the other hand, if the energy-saving restrained state 1203 of the functional module of which energy-saving state is to be controlled is “OFF”, the energy-saving controller 602 terminates the present process without carrying out any processing.

If it is determined in the step S1303 that the energy-saving control condition is the energy-saving starting condition, the energy-saving controller 602 refers to the energy-saving restrained states 1203 of the table 1200 and determines the energy-saving restrained state of the functional module of which energy-saving state is to be controlled (step S1310). If the energy-saving restrained state 1203 of the functional module of which energy-saving state is to be controlled is “OFF”, the energy-saving controller 602 starts energy-saving for the functional module and causes the energy saving state thereof to shift to a designated energy-saving level (step S1311). Then, the energy-saving controller 602 terminates the present process. On the other hand, if the energy-saving restrained state 1203 of the functional module of which energy-saving state is to be controlled is “ON”, the energy-saving controller 602 terminates the present process without starting energy-saving for the functional module.

As described above, according to the present embodiment, it is optimally control the cancellation and starting of energy-saving for a functional module to be operated with respect to each application.

Also, with the above-described manifest, it is possible to set the period of time to elapse until the functional module operated by each application is caused to shift to an energy-saving state and the level of energy-saving state of the functional module operated by each application, and hence the degradation of usability can be prevented.

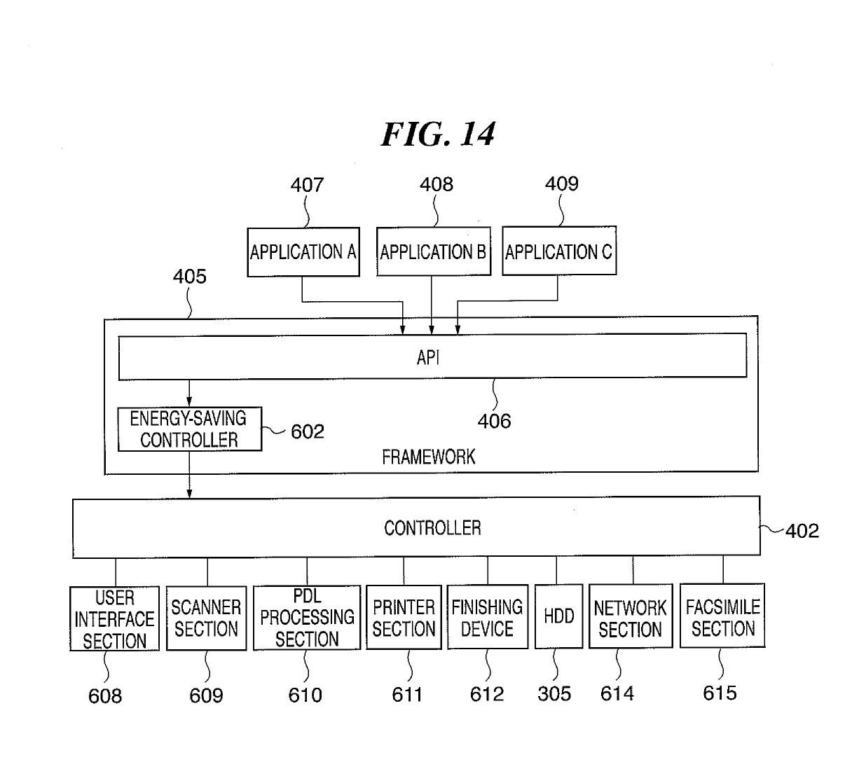

Next, a description will be given of a second embodiment of the present invention with reference to FIG. 14. FIG. 14 is a block diagram showing a software configuration capable of executing application programs in an image forming apparatus according to the second embodiment. Here, the same functional blocks as those of the first embodiment described above are denoted by the same reference numerals. Also, in the following description of the present embodiment, only differences between the present embodiment and the first embodiment will be described.

In the present embodiment, without the need for a manifest, it is possible to directly call up the energy-saving controller 602 via the API 406. With the applications 407, 408, and 409, the cancellation of energy-saving states of functional modules in the MFP and the shift of functional modules in the MFP to an energy-saving state can be arbitrarily controlled.

However, with the above arrangement of the present embodiment, at the time of application development, instructions relating to energy-saving control have to be embedded in applications themselves using the API 406. Specifically, in the present embodiment, since the cancellation of energy-saving and the shift to an energy-saving state can be arbitrarily controlled using the API 406, it takes more time and effort to change energy-saving control conditions at a later time as compared with the first embodiment.

Since the same object can be attained and the same results can be obtained in the above described first and second embodiments, the frameworks 405 may be constructed suitably for the respective embodiments.

It is to be understood that the object of the present invention may also be accomplished by supplying a system or an apparatus with a storage medium in which a program code of software, which realizes the functions of any of the above described embodiments is stored, and causing a computer (or CPU or MPU) of the system or apparatus to read out and execute the program code stored in the storage medium.

In this case, the program code itself read from the storage medium realizes the functions of any of the above described embodiments, and hence the program code and the storage medium in which the program code is stored constitute the present invention.

Examples of the storage medium for supplying the program code include a floppy® disk, a hard disk, a magneto-optical disk, a CD-ROM, a CD-R, a CD-RW, a DVD-ROM, a DVD-RAM, a DVD-RW, a DVD+RW, a magnetic tape, a nonvolatile memory card, and a ROM. Alternatively, the program code may be downloaded via a network.

Further, it is to be understood that the functions of any of the above described embodiments may be accomplished not only by executing a program code read out by a computer, but also by causing an OS (operating system) or the like which operates on the computer to perform a part or all of the actual operations based on instructions of the program code.

Further, it is to be understood that the functions of any of the above described embodiments may be accomplished by writing a program code read out from the storage medium into a memory provided on an expansion board inserted into a computer or in an expansion unit connected to the computer and then causing a CPU or the like provided in the expansion board or the expansion unit to perform a part or all of the actual operations based on instructions of the program code.

While the present invention has been described with reference to exemplary embodiments, it is to be understood that the invention is not limited to the disclosed exemplary embodiments. The scope of the following claims is to be accorded the broadest interpretation so as to encompass all modifications, equivalent structures and functions.

This application claims the benefit of Japanese Patent Application No. 2006-145451, filed May 25, 2006, which is hereby incorporated by reference herein in its entirety.

What is claimed is:

1. An image forming apparatus including at least one functional module, comprising:
a designating unit adapted to designate energy-saving control conditions for at least one functional module with respect to each application of the image forming apparatus; and
an energy-saving control unit adapted to control an energy-saving state of the functional module according to the energy-saving control conditions designated with respect to each application by said designating unit.

2. An image forming apparatus according to claim 1, wherein the application is associated with a manifest in which energy-saving control conditions for at least one functional module for realizing one function are described.

3. An image forming apparatus according to claim 2, wherein the energy-saving control conditions include an energy-saving canceling condition for canceling an energy-saving state of the functional module operated by the application, and an energy-saving starting condition for causing the functional module operated by the application to shift to the energy-saving state.

4. An image forming apparatus according to claim 3, wherein the energy-saving starting condition includes levels of energy-saving state of the functional module operated by the application.

5. An image forming apparatus according to claim 3, wherein the energy-saving starting condition includes a period of time to elapse until the functional module operated by the application is caused to shift to the energy-saving state.

6. An image forming apparatus according to claim 3, wherein the energy-saving control conditions include an energy-saving restraint canceling condition for canceling an energy-saving restrained state in which the functional module operated by the application is restrained from shifting to the energy-saving state, and an energy-saving restraint starting condition for causing the functional module operated by the application to shift to the energy-saving restrained state, and
said energy-saving control unit is adapted to carry out an energy-saving control process including cancellation of the energy-saving state of the functional module operated by the application and shift of the functional module operated by the application to shift to the energy-saving state, and cancellation of the energy-saving restrained state and shift to the energy-saving state.

7. A method of controlling an image forming apparatus including at least one functional module, comprising:
a designating step of designating energy-saving control conditions for at least one functional module with respect to each application of the image forming apparatus; and
an energy-saving control step of controlling an energy-saving state of the functional module according to the energy-saving control conditions designated with respect to each application in said designating step.

8. A method of controlling an image forming apparatus according to claim 7, wherein the application is associated with a manifest in which energy-saving control conditions for at least one functional module for realizing one function are described.

9. A method of controlling an image forming apparatus according to claim 8, wherein the energy-saving control conditions include an energy-saving canceling condition for canceling an energy-saving state of the functional module operated by the application, and an energy-saving starting condition for causing the functional module operated by the application to shift to the energy-saving state.

10. A method of controlling an image forming apparatus according to claim 9, wherein the energy-saving starting condition includes levels of energy-saving state of the functional module operated by the application.

11. A method of controlling an image forming apparatus according to claim 9, wherein the energy-saving starting condition includes a period of time to elapse until the functional module operated by the application is caused to shift to the energy-saving state.

12. A method of controlling an image forming apparatus according to claim 9, wherein the energy-saving control conditions include an energy-saving restraint canceling condition for canceling an energy-saving restrained state in which the functional module operated by the application is restrained from shifting to the energy-saving state, and an energy-saving restraint starting condition for causing the functional module operated by the application to shift to the energy-saving restrained state, and
an energy-saving control process is carried out in said energy-saving control step, the energy-saving control process including cancellation of the energy-saving state of the functional module operated by the application and shift of the functional module operated by the application to shift to the energy-saving state, and cancellation of the energy-saving restrained state and shift to the energy-saving state.

13. A program for causing a computer to execute a method of controlling an image forming apparatus including at least one functional module, comprising:
a designating module for designating energy-saving control conditions for at least one functional module with respect to each application of the image forming apparatus; and
an energy-saving control module for controlling an energy-saving state of the functional module according to the energy-saving control conditions designated with respect to each application by said designating module.

14. A computer-readable storage medium storing a program according to claim 13.
